(19) United States
(12) Patent Application Publication
(10) Pub. No.: US 2012/0110286 A1
(43) Pub. Date: May 3, 2012

(54) Image processing apparatus, power-saving recovery control method, and computer program product

(75) Inventor: Takahiro Yaoyama, Tokyo (JP)

(73) Assignee: Ricoh Company, Limited, Tokyo (JP)

(21) Appl. No.: 13/317,643

(22) Filed: Oct. 25, 2011

(30) Foreign Application Priority Data
Oct. 29, 2010 (JP) 2010-244835
Sep. 5, 2011 (JP) 2011-192597

(51) Int. Cl. G06F 12/16; G06F 1/32

(52) U.S. Cl. 711/161; 713/320; 711/E12.103

(57) ABSTRACT

An image processing apparatus including: a first storage unit; a second storage unit that has a higher storage capacity than that of the first storage unit and a longer start-up time than that of the first storage unit; and a control unit that, after shifting to a power-saving mode in which power consumption is reduced by shutting off power supply at least to the second storage unit, starts a recovery process from the power-saving mode upon occurrence of a recovery request from the power-saving mode to perform a processing operation using the second storage unit, starts the processing operation with the first storage unit as a data storing destination when the first storage unit is ready for use, and switches the data storing destination from the first storage unit to the second storage unit when the second storage unit is ready for use.

### CROSS-REFERENCE TO RELATED APPLICATIONS

The present application claims priority to and incorporates by reference the entire contents of Japanese Patent Application No. 2010-244835 filed in Japan on Oct. 29, 2010 and Japanese Patent Application No. 2011-192597 filed in Japan on Sep. 5, 2011.

### BACKGROUND OF THE INVENTION

1. Field of the Invention

The present invention relates to an image processing apparatus, a power-saving recovery control method, and a computer program product. More specifically, the present invention relates to an image processing apparatus, a power-saving recovery control method, and a computer program product for promptly initiating an operation using a long start-up time nonvolatile storage unit, such as a hard disk drive, at the recovery from a power-saving mode.

2. Description of the Related Art

An image processing apparatus, such as a facsimile machine, a copying machine, a printer, a multifunction peripheral, or a scanner, stores image data in a hard disk drive (HDD), and prints out the image data stored in the HDD or outputs the image data stored in the HDD to an external device; or, the image processing apparatus stores image data transmitted from an external device in the HDD, and then prints out the image data or outputs the image data to another external device.

Meanwhile, in recent years, there is a demand for energy saving. Also, there has been a conventional technology according to which an image processing apparatus shifts to an energy-saving mode (a power-saving mode) in which power consumption is reduced by shutting off the power supply to devices other than a device which performs an energy-saving recovery function, such as an application specific integrated circuit (ASIC), after an elapse of a predetermined waiting time during which the image processing apparatus is not in use. After the shift to the energy-saving mode, upon occurrence of recovery factor from energy saving, such as an operation made on an operation display unit, a setting of an original on an original plate of a scanner, or a request for communication from an external device, the ASIC resumes the power supply to the devices including an HDD and brings the devices back to a normal operating state.

However, in the conventional image processing apparatus including a long start-up time nonvolatile storage unit which requires some extent of time for recovery, such as the HDD, for storing image data as described above (hereinafter, simply referred to as the HDD), it is a condition of completing the recovery from the energy-saving mode to bring the HDD back to a ready state. Therefore, a recovery time from the energy-saving mode to the normal operating mode depends on a time required for recovery of the HDD.

Furthermore, conventionally, there has been proposed a technology to restore the image processing apparatus to a state before shifting to the energy-saving mode in such a manner that state information on a state of a memory and a state of a register of a central processing unit (CPU) is acquired in shifting to the energy-saving mode, and the acquired state information is divided into two pieces, and thereafter, the divided two pieces of state information are stored in two different types of nonvolatile storage devices which differ in readout time, respectively, and at the recovery from the energy-saving mode, the stored two pieces of state information are acquired from the storage devices sequentially from the storage device ready for readout first, and then the state information is redefined in the memory and the register of the CPU (see Japanese Patent Application Laid-open No. 2010-124076).

In the above conventional technology disclosed in Japanese Patent Application Laid-open No. 2010-124076, the state information of the CPU and the state information of the memory are stored in the two different types of nonvolatile memories which differ in readout time, respectively, and at the recovery from the energy-saving mode, the two pieces of state information are read out from the nonvolatile memories sequentially from the nonvolatile memory ready for readout first and set in the memory and the CPU; therefore, it is possible to reduce a recovery time. However, an operation using a nonvolatile memory which takes a relatively long time for recovery, such as the HDD, is not taken into account. Therefore, as for the operation using the nonvolatile memory such as the HDD, a recovery time from the energy-saving mode still depends on a time required for recovery of the nonvolatile memory such as the HDD, so that there has been a necessity of improvement to improve the usability.

### SUMMARY OF THE INVENTION

It is an object of the present invention to at least partially solve the problems in the conventional technology.

According to an aspect of the present invention, there is provided an image processing apparatus including: a first storage unit; a second storage unit that has a higher storage capacity than that of the first storage unit and a longer start-up time than that of the first storage unit; and a control unit that, after shifting to a power-saving mode in which power consumption is reduced by shutting off power supply at least to the second storage unit, starts a recovery process from the power-saving mode upon occurrence of a recovery request from the power-saving mode to perform a processing operation using the second storage unit, starts the processing operation with the first storage unit as a data storing destination when the first storage unit is ready for use, and switches the data storing destination from the first storage unit to the second storage unit when the second storage unit is ready for use.

According to another aspect of the present invention, there is provided a recovery control method including: a first storing processing to store data in a first storage unit; a second storing processing to store data in a second storage unit having a higher storage capacity than that of the first storage unit and a longer start-up time than that of the first storage unit; and process controlling, after shifting to a power-saving mode in which power consumption is reduced by shutting off power supply at least to the second storage unit, starting a recovery process from the power-saving mode upon occurrence of a recovery request from the power-saving mode to perform a processing operation using the second storage unit, performing the first storing processing when the first storage unit is ready for use to store data in the first storage unit, switching the data storing destination to the second storage unit when the second storage unit is ready for use, and performing the second storing processing to store data in the second storage unit.

According to still another aspect of the present invention, there is provided a computer program product including a non-transitory computer-usable medium having a computer-readable program code embodied in the medium that causes a computer to execute: a first storing processing to store data in a first storage unit; a second storing processing to store data in a second storage unit having a higher storage capacity than that of the first storage unit and a longer start-up time than that of the first storage unit; and process controlling, after shifting to a power-saving mode in which power consumption is reduced by shutting off power supply at least to the second storage unit, starting a recovery process from the power-saving mode upon occurrence of a recovery request from the power-saving mode to perform a processing operation using the second storage unit, performing the first storing processing when the first storage unit is ready for use to store data in the first storage unit, switching the data storing destination to the second storage unit when the second storage unit is ready for use, and performing the second storing processing to store data in the second storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block configuration diagram of main parts of an image forming apparatus according to an embodiment;

FIG. 2 is a diagram illustrating a shift of an energy-saving recovery process accompanied by a manual change of a data-storing destination;

FIG. 3 is a diagram illustrating a shift of a process to lift a limit on the number of pages to be scanned on the basis of time;

FIG. 4 is a diagram illustrating a shift of a process to lift the limit on the number of pages to be scanned on the basis of a recovery completion notification from an HDD;

FIG. 5 is a flowchart showing an example of the energy-saving recovery process;

FIG. 6 is a diagram showing an example of a method for handling scan files; and

FIG. 7 is a flowchart showing an example of the energy-saving recovery process according to a first modification of the embodiment.

### DETAILED DESCRIPTION OF THE PREFERRED EMBODIMENTS

Exemplary embodiments are explained in detail below with reference to the accompanying drawings. Incidentally, the embodiments described below are preferred embodiments, so that various technically-preferred limitations are imposed thereon; however, the scope of the invention is not unduly limited to the description below, and all configurations described in the present embodiments are not the necessary components of the present invention.

### First Embodiment

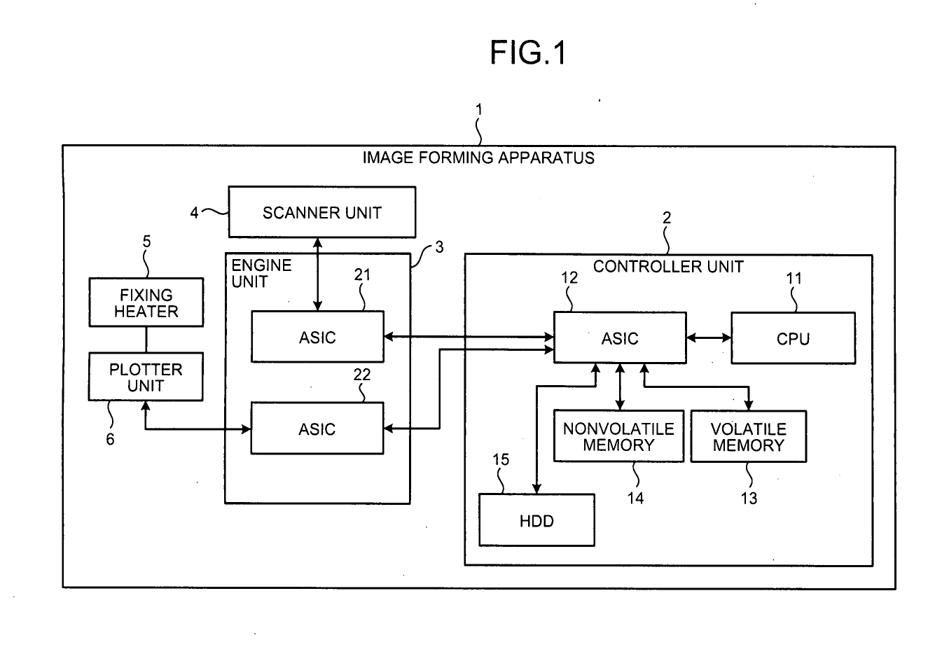

FIGS. 1 to 7 are diagrams showing an embodiment of an image processing apparatus, a power-saving recovery control method, and a computer program product. FIG. 1 is a block configuration diagram of main parts of an image forming apparatus 1 as an example of the application of the image processing apparatus, the power-saving recovery control method, and the computer program product according to the embodiment.

As shown in FIG. 1, the image forming apparatus 1 includes a controller unit 2, an engine unit 3, a scanner unit 4, a fixing heater 5, a plotter unit 6, and the like. Furthermore, although not shown in FIG. 1, the image forming apparatus 1 further includes an operation display unit, a communication unit, and the like. Various operations are made through the operation display unit, and necessary information is displayed on the operation display unit. The communication unit establishes a connection with an external device, such as an external computer, and exchanges data or a signal with external device.

The controller unit 2 includes a CPU 11, an ASIC 12, a volatile memory 13, a nonvolatile memory 14, an HDD 15, and the like. The engine unit 3 includes an ASIC 21, an ASIC 22, and the like.

The image forming apparatus 1 has an energy-saving mode (a power-saving mode) in which power consumption is reduced by shutting off or reducing the power supply to certain units that consume a large amount of power, such as the fixing heater 5, the plotter unit 6, the scanner unit 4, the engine unit 3, and the HDD 15 in the controller unit 2, after an elapse of a waiting time preset for a standby state. Furthermore, in the energy-saving mode, upon occurrence of a recovery factor, such as a setting of an original in the scanner unit 4, an operation on the operation display unit, or a request for communication from an external device, the ASIC 12 detects the recovery factor, and performs a recovery process for recovery to a state in which an operation requested in the recovery factor can be performed.

The CPU 11 in the controller unit 2 performs a basic process as the image forming apparatus 1 using the volatile memory 13 as a working memory by controlling the units in the image forming apparatus 1 on the basis of a basic program of the image forming apparatus 1 and a computer program product according to the present embodiment which are stored in a read-only memory (ROM) (not shown) or the HDD 15.

The ASIC (control unit) 12 performs predetermined image processing on received image data, which has been processed by and transmitted from the engine unit 3, under the control of the CPU 11, and then stores the processed image data in the nonvolatile memory 14 or the HDD 15. The ASIC 12 is supplied with power even in the energy-saving mode, detects the occurrence of an energy-saving recovery factor, and performs the energy-saving recovery process. Furthermore, in the recovery process from the energy-saving mode to be described later, the ASIC 12 performs a power-saving recovery control process (an energy-saving recovery control process) in which a recovery time is reduced by using the nonvolatile memory 14 at the recovery to an operation mode in which the HDD 15 is used.

Namely, the image forming apparatus 1 is constructed as an image processing apparatus that loads the computer program product recorded on a computer-readable recording medium for executing a power-saving recovery control method and stores the computer program product in the ROM or the HDD 15 and executes the power-saving recovery control method for reducing a recovery time, to be described below, from the energy-saving mode to the operation mode using the HDD 15 to improve the usability. The computer-readable recording medium is a ROM, an Electronically Erasable and Programmable Read Only Memory (EEPROM), an EPROM, a flash memory, a flexible disk, a Compact Disc Read Only Memory (CD-ROM), a Compact Disc ReWritable (CD-RW), a Digital Versatile Disk (DVD), an Secure Digital (SD) card, or an Magneto-Optical Disc (MO). This computer program product is a computer-executable program written in a legacy programming language or an object-oriented programming language, such as assembler, C, C++, C#, or Java (registered trademark), or the like, and can be distributed by storing the computer program product in the recording medium.

The nonvolatile memory (short start-up time nonvolatile storage unit) 14 stores therein various data to be stored even when the image forming apparatus 1 is powered off under the control of the ASIC 12. Furthermore, when an energy-saving fast recovery mode is set at the power-saving recovery process to be described below, the nonvolatile memory 14 stores therein image data of an original read by the scanner unit 4.

In the HDD (long start-up time nonvolatile storage unit) 15, various types of data and computer programs, and particularly image data are written and read by the ASIC 12 under the control of the CPU 11.

As the scanner unit 4, for example, an image scanner including a Charge Coupled Device (CCD) or a Complementary Metal Oxide Semiconductor (CMOS) is used. The scanner unit 4 scans an original, and reads an image of the original at a predetermined resolution, and then outputs the read image to the ASIC 21 in the engine unit 3.

The engine unit 3 is connected to the scanner unit 4, the fixing heater 5, and the plotter unit 6, and controls the operation of these units. Furthermore, the engine unit 3 causes the ASIC 21 or the ASIC 22 to perform image processing on image data. The engine unit 3 outputs image data processed by the ASIC 21 to the ASIC 12 in the controller unit 2. On the other hand, the ASIC 22 performs image processing necessary for printing out by the plotter unit 6 on image data read by the scanner unit 4 or image data read out from the HDD 15 of the controller unit 2, and thereafter, the engine unit 3 outputs the processed image data to the plotter unit 6 and controls the operation of the plotter unit 6 to cause the plotter unit 6 to print out an image on a sheet on the basis of the image data.

That is, the ASIC 21 controls the operation of the scanner unit 4 to cause the scanner unit 4 to read image data of an original, and performs predetermined image processing on the image data of the original read by the scanner unit 4 (hereinafter, referred to as “scanner data” as appropriate), and then outputs the processed image data to the controller unit 2.

The ASIC 22 performs image processing appropriate to be printed out by the plotter unit 6 on image data received from the ASIC 21 or image data received from the controller unit 2, and outputs the processed image data to the plotter unit 6 and controls the operation of the plotter unit 6 to cause the plotter unit 6 to print out the image on a sheet. Furthermore, the ASIC 22 performs image processing appropriate for a data transfer to an external device on image data received from the ASIC 21 or image data received from the controller unit 2, and transmits the processed image data to the external device via the communication unit.

The plotter unit 6 is an electrophotographic plotter. Although not shown in FIG. 1, the plotter unit 6 includes components required to perform a process of printing an image on a sheet on the basis of rendering data by an electrophotographic printing method; for example, the plotter unit 6 includes a photoreceptor, an optical writing unit, a developing unit, a charging unit, a cleaning unit, and the like. The printing process is performed in such a manner that upon receipt of image data and a control signal from the ASIC 22 of the engine unit 3, the plotter unit 6 causes the optical writing unit to form an electrostatic latent image on the photoreceptor and then causes the developing unit to supply toner onto the photoreceptor thereby developing the electrostatic latent image into a toner image. The plotter unit 6 feeds a sheet from a sheet feed unit into a gap between the photoreceptor and a transfer unit, and transfers the toner image formed on the photoreceptor onto the sheet, and then conveys the sheet onto which the toner image has been transferred to a fixing unit. The fixing unit includes a fixing roller and a pressure roller. The fixing roller is heated by the fixing heater 5, and driven to rotate at a predetermined constant rotation speed. The pressure roller is pressed against the fixing roller at a predetermined pressure, and rotates in accordance with the rotation of the fixing roller. The fixing unit applies heat and pressure to the sheet onto which the toner image has been transferred with the fixing roller heated to the fixing temperature and the pressure roller, thereby fixing the toner image on the sheet.

The fixing heater 5 generates heat by electric conduction controlled by the ASIC 22 of the engine unit 3, and heats the fixing roller of the fixing unit in the plotter unit 6.

In the image forming apparatus 1, the recovery time to be ready for use after starting the energy-saving recovery process varies from one unit to another unit. For example, the fixing roller heated by the fixing heater 5 takes the longest recovery time until the temperature of the fixing roller reaches the fixing temperature and becomes stable at the fixing temperature, and this recovery time takes several tens of seconds. Among other parts, the HDD 15 has the longest recovery time to be ready for use to take several seconds.

Subsequently, the action of the present embodiment is explained. In the energy-saving mode, upon request for recovery to the operation using the HDD 15, the image forming apparatus 1 according to the present embodiment uses the nonvolatile memory 14 as an access destination instead of the HDD 15 without waiting for recovery of the HDD 15. Therefore, a recovery process required to perform the requested operation is completed promptly, and the requested operation is performed.

That is, the image forming apparatus 1 has the energy-saving mode in which power consumption is reduced by shutting off or reducing the power supply to certain units that consume a large amount of power, such as the fixing heater 5, the plotter unit 6, the scanner unit 4, the engine unit 3 including the ASICs 21 and 22, the CPU 11, and the HDD 15 included in the controller unit 2, after the elapse of a predetermined waiting time in a standby mode. In the energy-saving mode, upon request for recovery to the operation using the HDD 15, such as a scanner operation, an operation requesting for data transfer from an external device, or an operation requesting for data transmission, the image forming apparatus 1 performs the recovery process from the energy-saving mode. As the recovery process, the image forming apparatus 1 has the energy-saving fast recovery mode and a mass scan mode. The energy-saving fast recovery mode is a mode in which the nonvolatile memory 14 is used as an access destination of image data instead of the HDD 15, thereby promptly completing a recovery process required to perform a requested operation and promptly performing the operation requested in an energy-saving recovery request. The mass scan mode is a mode in which the HDD 15 is used as an access destination of image data, and an operation requested in an energy-saving recovery request is performed after the HDD 15 becomes ready for use. The energy-saving fast recovery mode and the mass scan mode are set and stored in the nonvolatile memory 14 in advance as default recovery modes at the recovery. The default recovery mode can be switched between the energy-saving fast recovery mode and the mass scan mode as appropriate by user operation on the operation display unit or the like. Incidentally, because a storage capacity of the nonvolatile memory 14 is smaller than the HDD 15, the number of scannable pages (a processable data amount) is small in the energy-saving fast recovery mode.

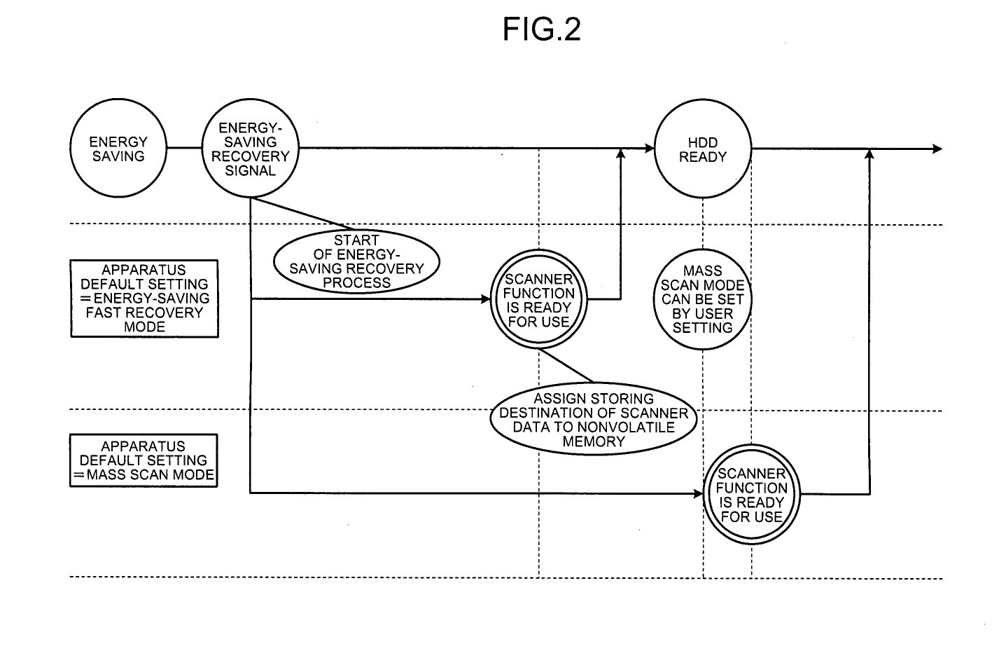

First, an energy-saving recovery process accompanied by a manual change of a data-storing destination is explained with reference to FIG. 2. The energy-saving recovery process accompanied by a manual change of a data-storing destination is a process that if the default recovery mode from the energy-saving mode is the energy-saving fast recovery mode, image data read by the scanner unit 4 and image data transmitted from an external device are stored in the nonvolatile memory 14 as a storing destination of the image data, and when the HDD 15 becomes ready for use, the storing destination of image data is switched from the nonvolatile memory 14 to the HDD 15 by manual operation on the operation display unit to store image data in the HDD 15.

When the default recovery mode is set to the energy-saving fast recovery mode, upon occurrence of a recovery factor (occurrence of recovery signal from energy saving), such as a setting of an original in the scanner unit 4, an operation made on the operation display unit, or a request for communication from an external device, the ASIC 12 of the controller unit 2 detects the recovery factor. The ASIC 12 begins a recovery process for recovery to a state in which an operation requested in the detected recovery factor (the operation using the HDD 15) can be implemented.

Incidentally, in the description below, the requested operation shall be an operation requesting the scanner unit 4 to read image data of an original and store the read image data. This can be also applied similarly to the case where the requested operation is an operation requesting the image forming apparatus 1 to store image data transmitted from an external device and the case where the requested operation is an operation requesting the image forming apparatus 1 to transfer image data stored in the image forming apparatus 1 to an external device.

When a request indicated in the energy-saving recovery factor is a request for storage of image data or transfer of image data, the recovery time for the recovery of the HDD 15 takes several seconds as described above. Therefore, the image forming apparatus 1 sets the nonvolatile memory 14 as an access destination to store image data at least until the HDD 15 becomes ready for use and stores image data in the nonvolatile memory 14 or reads out image data from the nonvolatile memory 14. In general, a memory capacity of the nonvolatile memory 14 is smaller than that of the HDD 15. Therefore, the number of scannable pages (a processable data amount) is set in advance, and upon occurrence of recovery factor from energy saving, the CPU 11 may display the number of scannable pages on a display of the operation display unit or transmit information on the number of scannable pages to an external device that has requested for the operation of an energy-saving recovery factor to notify the external device of the number of scannable pages.

Upon starting the recovery process from energy saving, the image forming apparatus 1 checks whether a scanner function to cause the scanner unit 4 to read an original is ready for use. When the scanner function is ready for use (ready for use), the image forming apparatus 1 assigns a storing destination of image data of the original read by the scanner unit 4 (scanner data) to the nonvolatile memory 14. The image forming apparatus 1 sequentially stores scanner data of the original read by the scanner unit 4 in the nonvolatile memory 14.

While storing the scanner data in the nonvolatile memory 14, the image forming apparatus 1 performs an energy-saving recovery process for recovery of the HDD 15. Upon completion of the recovery process of the HDD 15, when the HDD 15 becomes ready for use (an HDD Ready state), the image forming apparatus 1 displays a message that the HDD 15 is ready for use on the display of the operation display unit to notify a user of the recovery of the HDD 15. Or, it can be configured that the image forming apparatus 1 notifies the external device that the HDD 15 is ready for use. Even if the image forming apparatus 1 notifies of information that the HDD 15 is ready for use, unless the storing destination of image data is changed from the nonvolatile memory 14 to the HDD 15 by user operation on the operation display unit or the like, the image forming apparatus 1 stores scanner data in the nonvolatile memory 14. After a user changes the storing destination of image data from the nonvolatile memory 14 to the HDD 15, the image forming apparatus 1 changes the data storing destination to the HDD 15 that is ready for use, and sequentially stores scanner data in the HDD 15.

Furthermore, when the default recovery mode is set to the mass scan mode, upon occurrence of a recovery factor from energy saving, the image forming apparatus 1 begins an energy-saving recovery process. Upon completion of a recovery process for recovery of the HDD 15, the image forming apparatus 1 stores scan data in the HDD 15. In this case, the number of scannable pages (a data amount) is determined by an upper limit of a free space on the HDD 15.

As described above, the image forming apparatus 1 stores scanner data read by the scanner unit 4 in the nonvolatile memory 14 at least until the HDD 15 becomes ready for use. Therefore, in a state where image data is stored in the nonvolatile memory 14 in this way, the image forming apparatus 1 shifts to the energy-saving mode, and in the energy-saving mode, when the default recovery mode is the energy-saving fast recovery mode, upon request for access from an external device as an energy-saving recovery factor, the image forming apparatus 1 can allow the external device to access the nonvolatile memory 14 after the nonvolatile memory 14 becomes ready for use. Therefore, a time necessary to begin transferring image data can be reduced as compared with the case of using the HDD 15.

Furthermore, in the energy-saving mode in which the default recovery mode is set to the energy-saving fast recovery mode, when a request for accessing the nonvolatile memory 14 to store image data in the nonvolatile memory 14 arrives as an energy-saving recovery factor from an external device, the image forming apparatus 1 begins an energy-saving recovery process. When the nonvolatile memory 14 becomes ready for use, the image forming apparatus 1 allows the external device to access the nonvolatile memory 14 and store image data in the nonvolatile memory 14. Therefore, a time taken to begin transferring image data by the external device since starting the energy-saving recovery process can be reduced as compared with the case of using the HDD 15.

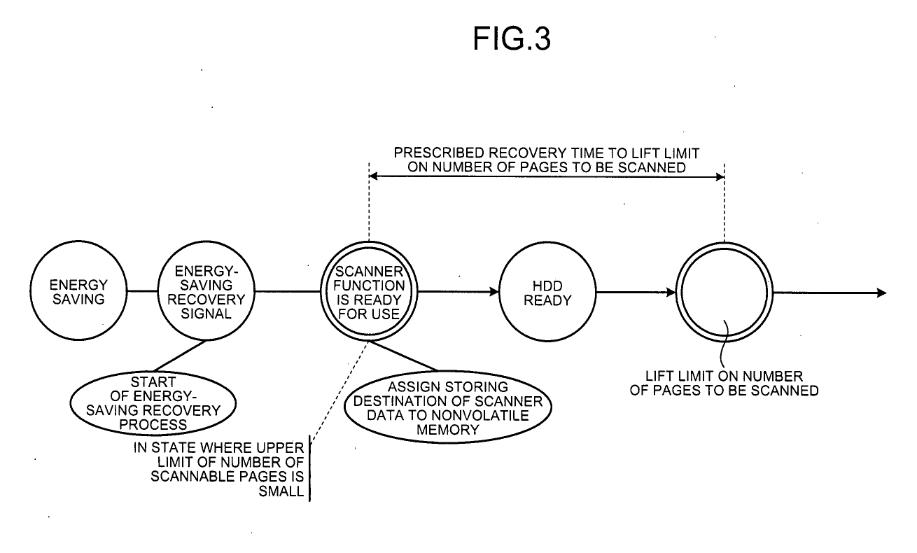

As a method to determine completion of the recovery process of the HDD 15 and lift the limit on the number of scannable pages, for example, the following method can be applied. First, as shown in FIG. 3, a prescribed recovery time from when the scanner function is ready for use is preset and stored in the nonvolatile memory 14. Then, in the energy-saving mode, upon occurrence of a recovery factor from energy saving, the image forming apparatus 1 begins an energy-saving recovery process. After a recovery process of the scanner unit 4 is completed and the scanner function of the scanner unit 4 is ready for use, the image forming apparatus 1 times the prescribed recovery time using a timer (not shown) included in the controller unit 2. After the elapse of the prescribed recovery time, the image forming apparatus 1 allows storage of scanner data read by the scanner unit 4 in the HDD 15. Furthermore, when the energy-saving recovery factor is a request for access from an external device, as described above, as for access to the nonvolatile memory 14, the image forming apparatus 1 allows the external device to access the nonvolatile memory 14 once the nonvolatile memory 14 is ready for use. Furthermore, as for access to the HDD 15, the image forming apparatus 1 allows the external device to access the HDD 15 after the elapse of the prescribed recovery time since the scanner function has been ready for use. In this case, if a user changes the storing destination of image data from the nonvolatile memory 14 to the HDD 15, the image forming apparatus 1 changes the storing destination from the nonvolatile memory 14 to the HDD 15 ready for use, and sequentially stores scanner data in the HDD 15.

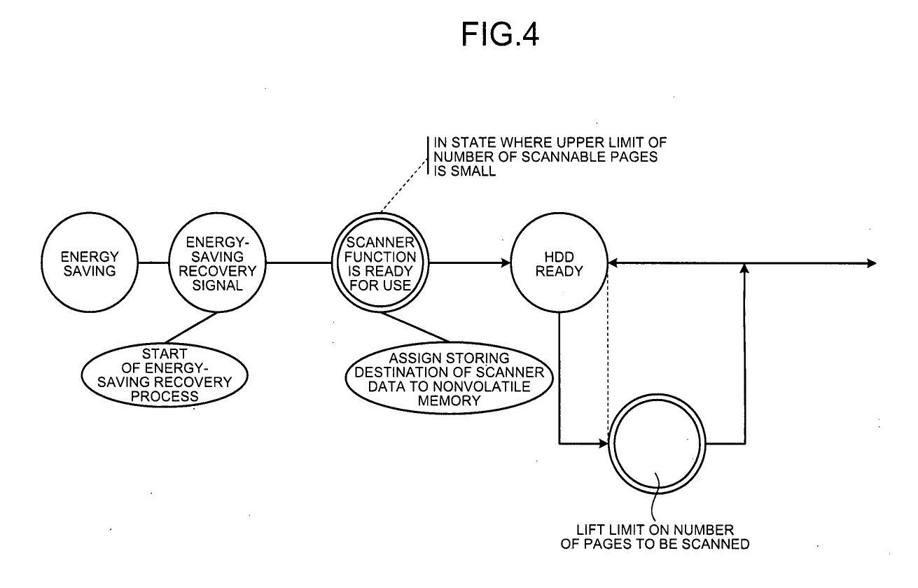

Furthermore, as another method to determine completion of the recovery process of the HDD 15 and lift the limit on the number of scannable pages, for example, as shown in FIG. 4, a method to determine completion of the recovery process upon receipt of a recovery completion notification (a Ready signal) from the HDD 15 can be applied.

In this case, in the energy-saving mode in which the default recovery mode is set to the energy-saving fast recovery mode, upon occurrence of a recovery factor from energy saving, for example, an energy-saving recovery factor requesting for a scanner operation to store scanner data, as shown in FIG. 4, the image forming apparatus 1 begins an energy-saving recovery process. When the scanner function is ready for use, the image forming apparatus 1 performs a process to cause the scanner unit 4 with the limit on the number of scannable pages to start reading an original and sequentially store read scanner data of each page of the original in the nonvolatile memory 14 on a per-page basis. After that, upon completion of recovery of the HDD 15, when a recovery completion notification (a Ready signal) is output from the HDD 15, the ASIC 12 detects this recovery completion notification. Upon detection of the recovery completion notification, the image forming apparatus 1 switches the storing destination of scanner data from the nonvolatile memory 14 to the HDD 15, and stores scanner data read by the scanner unit 4 in the HDD 15.

Incidentally, also in this case, upon completion of a recovery process of the HDD 15, when the HDD 15 becomes ready for use, the image forming apparatus 1 displays a message that the HDD 15 is ready for use on the display of the operation display unit to notify a user of the recovery of the HDD 15, or notifies the external device that the HDD 15 is ready for use. Furthermore, the storing destination of scanner data can be switched from the nonvolatile memory 14 to the HDD 15 only when the image forming apparatus 1 is instructed to switch the storing destination of scanner data from the nonvolatile memory 14 to the HDD 15 by user operation on the operation display unit or the like.

Also in this case, as described above, the image forming apparatus 1 stores scanner data read by the scanner unit 4 in the nonvolatile memory 14 at least until the HDD 15 becomes ready for use. Therefore, in a state where image data is stored in the nonvolatile memory 14 in this way, the image forming apparatus 1 shifts to the energy-saving mode, and in the energy-saving mode, when the default recovery mode is the energy-saving fast recovery mode, upon receiving request for access from an external device as an energy-saving recovery factor, the image forming apparatus 1 can allow the external device to access the nonvolatile memory 14 when the nonvolatile memory 14 becomes ready for use. Therefore, a time taken to begin transferring image data can be reduced as compared with the case of using the HDD 15. Furthermore, in the energy-saving mode in which the default recovery mode is set to the energy-saving fast recovery mode, as an energy-saving recovery factor, upon receiving request for access to the nonvolatile memory 14 to store image data in the nonvolatile memory 14 from an external device, the image forming apparatus 1 begins an energy-saving recovery process. When the nonvolatile memory 14 becomes ready for use, the image forming apparatus 1 allows the external device to access the nonvolatile memory 14 and store image data in the nonvolatile memory 14. Therefore, a time taken to begin transferring image data can be reduced as compared with the case of using the HDD 15.

As described above, in the present embodiment, to achieve fast recovery from the energy-saving mode, scanner data is stored preferentially in the nonvolatile memory 14 having a fast access time. However, because a storage capacity of the nonvolatile memory 14 is low, a limit is imposed on the number of scannable pages. The number of scannable pages is preset, for example, to the number of pages that can be stored in the nonvolatile memory 14 before the HDD 15 becomes ready for use. To lift the limit on the number of scannable pages, once the high-capacity HDD 15 becomes ready for use, scanner data corresponding to capacity shortage of the nonvolatile memory 14 is written in the HDD 15. If the number of pages scanned exceeds the number of scannable pages (for example, 10 pages), a part of scanner data is stored in the nonvolatile memory 14, and the rest of the scanner data that cannot be stored in the nonvolatile memory 14 is stored in the HDD 15. Furthermore, scanner data of a plurality of pages read in a single scan is combined into one file. For example, it can be configured that at the end of the scan, the scanner data written in the nonvolatile memory 14 is copied to the HDD 15, and the copied scanner data is combined with a file of the scanner data having stored in the HDD 15.

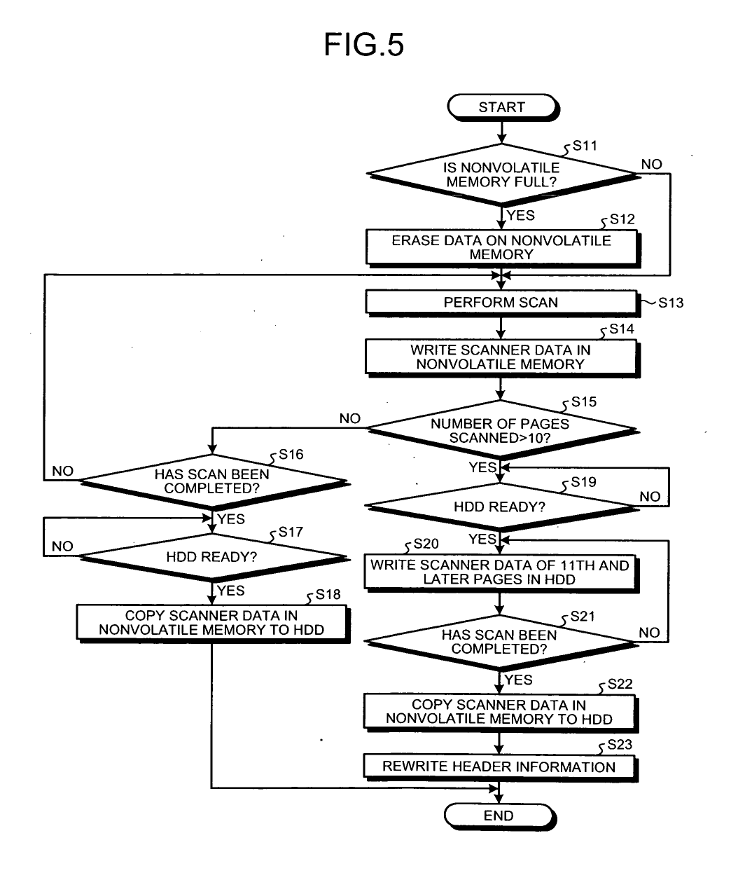

An energy-saving recovery process is explained in detail below with reference to FIG. 5. FIG. 5 is a flowchart showing an example of the energy-saving recovery process according to the first embodiment. A description is given below of the example in which the number of scannable pages is set to be 10 pages; however, the number of scannable pages is not limited to 10 pages. Furthermore, in the example described below, the default recovery mode is set to the energy-saving fast recovery mode, and an energy-saving recovery process upon occurrence of a recovery factor from energy saving in that an original is set in the scanner unit 4 is explained.

Upon detection of the recovery factor from energy saving, the ASIC 12 determines whether the nonvolatile memory 14 has no free space (i.e., the nonvolatile memory 14 is full) (Step S11). When the nonvolatile memory 14 is full (YES at Step S11), the ASIC 12 erases all or part of data stored in the nonvolatile memory 14 to create free space on the nonvolatile memory 14 (Step S12).

When the nonvolatile memory 14 is not full (NO at Step S11) or after Step S12, the scanner unit 4 performs a scan of the set original (Step S13). The ASIC 12 writes scanner data transmitted from the engine unit 3 in the nonvolatile memory 14 (Step S14). The ASIC 12 determines whether the number of pages scanned exceeds 10 pages which is the predetermined number of scannable pages (Step S15).

When the number of pages scanned does not exceed 10 pages (NO at Step S15), the ASIC 12 determines whether the scan has been completed (Step S16). When the scan has not been completed (NO at Step S16), the process sequence returns to Step S13, and the processes are repeated.

When the scan has been completed (YES at Step S16), the ASIC 12 determines whether the HDD 15 is ready for use (“HDD Ready”, in the example shown in FIG. 5) (Step S17). When the HDD 15 is not ready for use (NO at Step S17), the ASIC 12 waits until the HDD 15 becomes HDD Ready. When the HDD 15 becomes ready for use (HDD Ready) (YES at Step S17), the ASIC 12 copies the scanner data stored in the nonvolatile memory 14 to the HDD 15 (Step S18).

At Step S15, when it is determined that the number of pages scanned exceeds 10 pages (YES at Step S15), the ASIC 12 determines whether or not the HDD 15 is ready for use (HDD Ready) (Step S19). When the HDD 15 is not ready for use (NO at Step S19), the ASIC 12 waits until the HDD 15 becomes HDD Ready. When the HDD 15 becomes ready for use (YES at Step S19), the ASIC 12 writes scanner data of the 11th and later pages in the HDD 15 (Step S20).

The ASIC 12 determines whether the scan has been completed (Step S21). When the scan has not been completed yet (NO at Step S21), the process sequence returns to Step S20, and the process is repeated. When the scan has been completed (YES at Step S21), the ASIC 12 copies the scanner data stored in the nonvolatile memory 14 to the HDD 15 (Step S22). The ASIC 12 combines the copied scanner data (the scanner data of the 1st to 10th pages) and the scanner data written in the HDD 15 (the scanner data of the 11th and later pages) into one file. For example, the ASIC 12 rewrites the header of a file (a scan file) storing the scanner data written in the HDD 15 so as to contain the scanner data copied from the nonvolatile memory 14 to the HDD 15 (Step S23).

Incidentally, a method for managing the file is not limited to this, and any other methods can be applied as long as the methods can generate one file containing both scanner data stored in the nonvolatile memory 14 and the HDD 15 into which the scanner data read in a single scan is divided. By combining the scanner data into one file, for example, there is no need to merge the scanner data in the nonvolatile memory 14 and the scanner data in the HDD 15 at the distribution of the scanned data, and therefore, it is possible to speed up the distribution processing.

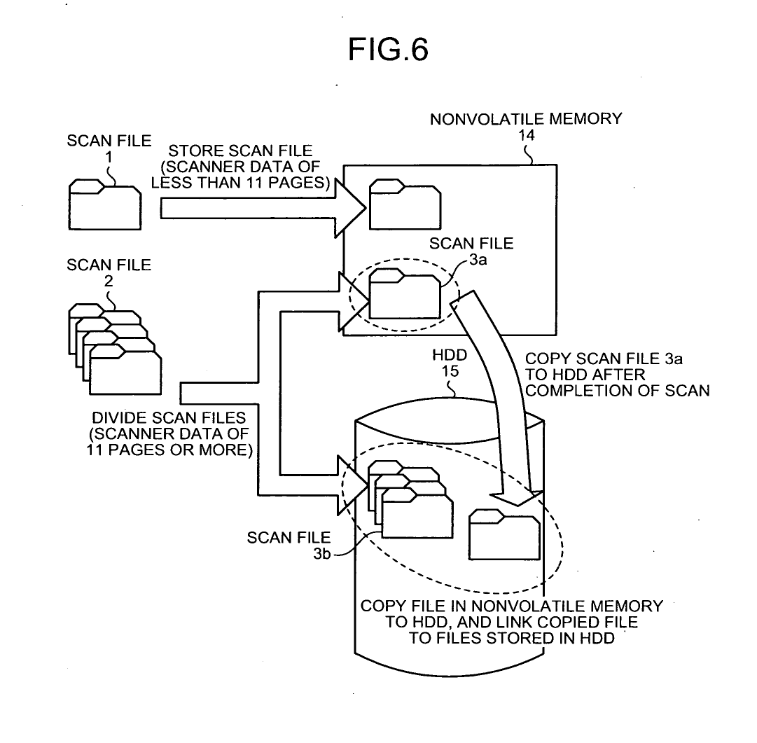

FIG. 6 is a diagram showing an example of a method for handling scan files. A scan file 1 denotes a file containing scanner data of less than 11 pages as a unit. In this case, the scan file 1 is stored in the nonvolatile memory 14 without being divided into a plurality of pieces.

A set of scan files 2 contains scanner data of 11 pages or more. Therefore, the set of scan files 2 is divided into a scan file 3a containing scanner data of the first 10 pages and a set of scan files 3b containing scanner data of the 11th and later pages, and the scan file 3a and the set of scan files 3b are stored in the nonvolatile memory 14 and the HDD 15, respectively. After completion of the scan, the scan file 3a stored in the nonvolatile memory 14 is copied to the HDD 15, and the scan files 3a and 3b are managed with the copied scan file 3a linked to the set of scan files 3b.

First Modification

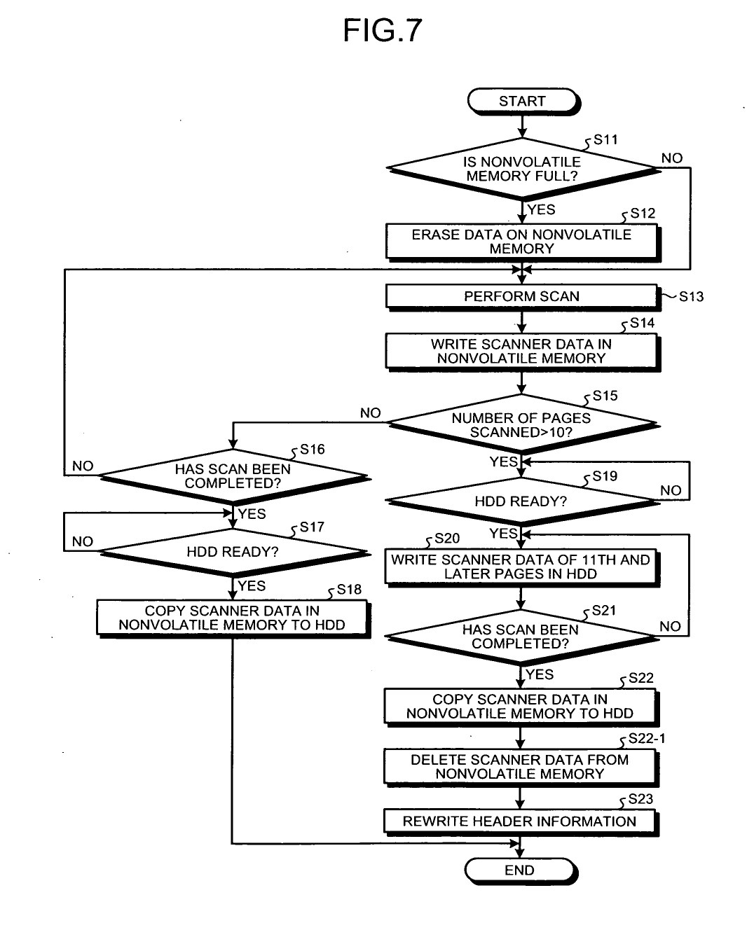

Incidentally, the scan file 3a having copied to the HDD 15 can be deleted from the nonvolatile memory 14. In a first modification of the first embodiment, a description is given of an example where copied data is deleted from the nonvolatile memory 14. FIG. 7 is a flowchart showing an example of the energy-saving recovery process according to the first modification. The flowchart shown in FIG. 7 differs from that in FIG. 5 in that Step S22-1 is added between Steps S22 and S23. The other steps in the flowchart of FIG. 7 are identical to those in FIG. 5, so that description of these steps is omitted.

At Step S22-1, the ASIC 12 deletes the scanner data having copied to the HDD 15 from the nonvolatile memory 14. This can increase an available capacity of the nonvolatile memory 14 while saving the scanner data having been stored in the nonvolatile memory 14 in the HDD 15, and therefore, it is possible to increase the number of scannable pages upon occurrence of a recovery factor from energy saving requiring the nonvolatile memory 14 as a storing destination at a subsequent time. As a result, it is possible to improve the usability of the image forming apparatus 1.

Incidentally, although not shown in FIG. 7, after the scanner data of less than 11 pages has been copied to the HDD 15 (Step S18), the copied scanner data can also be deleted from the nonvolatile memory 14. On the contrary, the controller unit 2 can be configured such that the scanner data having been copied to the HDD 15 are kept in the nonvolatile memory 14 even after the scanner data of less than 11 pages has been copied to the HDD 15 and the scanner data in the nonvolatile memory 14 are distributed. In the latter case, the scanner data in the nonvolatile memory 14 can be used even before the HDD 15 becomes ready for use, so that it is possible to speed up the distribution processing after scanning. In the former case, there is no need to link the scanner data before and after the copy by using the header part of the file or the like, so that it is easy to manage the scanner data.

Furthermore, it can be configured not to copy the scanner data to the HDD 15 after completion of the scan (Step S22) and not to delete the scanner data from the nonvolatile memory 14 (Step S22-1). Also in this configuration, it is possible to speed up the distribution processing, for example, if each of the files divided into the nonvolatile memory 14 and the HDD 15 can be distributed on a per-file basis.

In this manner, the image forming apparatus 1 according to the present embodiment includes the nonvolatile memory (short start-up time nonvolatile storage unit) 14, which has a relatively low memory capacity (storage capacity) and a relatively short start-up time, and the HDD (long start-up time nonvolatile storage unit) 15, which has a relatively high memory capacity (storage capacity) and a relatively long start-up time. After shifting to the energy-saving mode (the power-saving mode) in which power consumption is reduced by shutting off the power supply at least to the HDD 15, upon request for recovery from energy saving (request for recovery from power saving) to perform a processing operation using the HDD 15, the image forming apparatus 1 begins the recovery process from the energy-saving mode. When the nonvolatile memory 14 becomes ready for use, the image forming apparatus 1 begins the requested processing operation with the nonvolatile memory 14 as a data storing destination. When the HDD 15 becomes ready for use, the image forming apparatus 1 switches the data storing destination from the nonvolatile memory 14 to the HDD 15 automatically or according to user's selection.

Therefore, it is possible to detect a time required for recovery from the energy-saving mode and allow for operation processing, such as data storage or readout of stored data, regardless of a recovery time of the HDD 15 which takes a long time to start up, and possible to improve the usability.

Furthermore, the image forming apparatus 1 according to the present embodiment determines that the HDD 15 has been ready for use by timing a prescribed recovery time stored in the nonvolatile memory 14 as a time required for start-up of the HDD 15 in advance.

Therefore, the image forming apparatus 1 waits until the HDD 15 starts up certainly, and then can change the data storing destination from the nonvolatile memory 14 to the HDD 15 properly.

Moreover, the image forming apparatus 1 according to the present embodiment determines that the HDD 15 has been ready for use by detecting a recovery completion notification output when the HDD 15 has been ready for use.

Therefore, the image forming apparatus 1 can switch the data storing destination from the nonvolatile memory 14 to the HDD 15 according to a difference in start-up recovery time due to an individual difference of the HDD 15, and can perform the switching of the data storing destination certainly and promptly.

Furthermore, when the data storing destination has been switched from the nonvolatile memory 14 to the HDD 15, the image forming apparatus 1 according to the present embodiment copies data stored in the nonvolatile memory 14 to the HDD 15, and deletes the data from the nonvolatile memory 14.

Therefore, in data storage using the nonvolatile memory 14 at the next recovery from the energy saving mode, a larger area of memory can be used, and the usability can be improved.

Incidentally, in the above description, there is described the case where the HDD 15 is used as a long start-up time nonvolatile storage unit having a long start-up time; however, the long start-up time nonvolatile storage unit is not limited to an HDD, and a high-capacity nonvolatile memory such as a non-volatile random access memory (NVRAM) whose start-up time is relatively short but longer than a start-up time of the nonvolatile memory 14 can be used as the long start-up time nonvolatile storage unit.

According to the present embodiments, it is possible to reduce a time required for recovery from the energy-saving mode to a state in which operation processing, such as data storage or data readout, can be performed regardless of a recovery time of a long start-up time nonvolatile storage unit such as an HDD.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a first storage unit;
a second storage unit that has a higher storage capacity than that of the first storage unit and a longer start-up time than that of the first storage unit; and
a control unit that, after shifting to a power-saving mode in which power consumption is reduced by shutting off power supply at least to the second storage unit, starts a recovery process from the power-saving mode upon occurrence of a recovery request from the power-saving mode to perform a processing operation using the second storage unit, starts the processing operation with the first storage unit as a data storing destination when the first storage unit is ready for use, and switches the data storing destination from the first storage unit to the second storage unit when the second storage unit is ready for use.

2. The image processing apparatus according to claim 1, wherein
the control unit determines that the second storage unit has been ready for use by timing a prescribed recovery time, information of the prescribed recovery time being stored in advance in the first storage unit as a time required for start-up of the second storage unit.

3. The image processing apparatus according to claim 1, wherein
the control unit determines that the second storage unit has been ready for use by detecting a recovery completion notification output therefrom when the second storage unit has been ready for use.

4. The image processing apparatus according to claim 1, wherein
after switching the data storing destination from the first storage unit to the second storage unit, the control unit copies data stored in the first storage unit to the second storage unit, and deletes the data from the first storage unit.

5. The image processing apparatus according to claim 4, wherein
the control unit generates a file including data stored in the second storage unit and the data copied from the first storage unit to the second storage unit.

6. A recovery control method comprising:
a first storing processing includes storing data in a first storage unit;
a second storing processing includes storing data in a second storage unit having a higher storage capacity than that of the first storage unit and a longer start-up time than that of the first storage unit; and
process controlling includes, after shifting to a power-saving mode in which power consumption is reduced by shutting off power supply at least to the second storage unit,
starting a recovery process from the power-saving mode upon occurrence of a recovery request from the power-saving mode to perform a processing operation using the second storage unit,
performing the first storing processing when the first storage unit is ready for use to store data in the first storage unit,
switching the data storing destination to the second storage unit when the second storage unit is ready for use, and
performing the second storing processing to store data in the second storage unit.

7. A computer program product comprising a non-transitory computer-usable medium having a computer-readable program code embodied in the medium causing a computer to execute:
a first storing processing includes storing data in a first storage unit;
a second storing processing includes storing data in a second storage unit having a higher storage capacity than that of the first storage unit and a longer start-up time than that of the first storage unit; and
process controlling includes, after shifting to a power-saving mode in which power consumption is reduced by shutting off power supply at least to the second storage unit,
starting a recovery process from the power-saving mode upon occurrence of a recovery request from the power-saving mode to perform a processing operation using the second storage unit,
performing the first storing processing when the first storage unit is ready for use to store data in the first storage unit,
switching the data storing destination to the second storage unit when the, second storage unit is ready for use, and
performing the second storing processing to store data in the second storage unit.
